(19) United States
(12) Patent Application Publication
(10) Pub. No.: US 2015/0123606 A1
(43) Pub. Date: May 7, 2015

(54) Wireless Charging System with Data Tunneling

(71) Applicant: Amphenol Tecvox, LLC, Madison, AL (US)

(72) Inventor: Kum Weng Tew, Madison, AL (US)

(21) Appl. No.: 14/588,600

(22) Filed: Jan. 2, 2015

Related U.S. Application Data
(63) Continuation-in-part of application No. 14/532,622, filed on Nov. 4, 2014.
(60) Provisional application No. 62/058,993, filed on Oct. 2, 2014.
(60) Provisional application No. 61/899,367, filed on Nov. 4, 2013.

(51) Int. Cl. H02J 7/02

(52) U.S. Cl. CPC H02J 7/025
USPC 320/108

(57) ABSTRACT

A media system for a vehicle. The media system comprises a vehicle interface, a wireless charger configured for wirelessly charging a personal electronic device, and a gateway. The gateway is coupled to the vehicle interface via a first communications bus conforming to a first protocol and to the wireless charger via a second communications bus conforming to a second protocol different from the first protocol. The gateway is configured for converting messages transmitted on the second communications bus in accordance with the second protocol to messages transmitted on the first communications bus in accordance with the first protocol. The wireless charger is configured to receive data from the personal electronic device regarding a level of charge of a battery of the personal electronic device and to transmit the data to the media hub for display on the vehicle interface. The wireless charger also detects interference by an object during charging.

### CROSS REFERENCE TO RELATED APPLICATIONS

This application claims the benefit of U.S. Provisional Application No. 62/058,993, entitled “Media Hub with Feature Enhancement” and filed Oct. 2, 2014, the contents of which are incorporated herein by reference. This application is also a continuation-in-part of U.S. patent application Ser. No. 14/532,622, entitled “Detachable Charging System for a Vehicle” and filed Nov. 4, 2014, which claims the benefit of U.S. Provisional Patent Application No. 61/899,367, entitled “Detachable Charging Unit and Interface Device” and filed Nov. 4, 2013, the contents of which applications are also incorporated herein by reference.

### FIELD OF THE INVENTION

The present invention relates to a wireless charging system in a vehicle and, more specifically, to a wireless charging system integrated with a vehicle for charging a personal electronic device and providing data regarding a charging process of the personal electronic process to an interface of the vehicle over a non-vehicle-specific communications bus.

### BACKGROUND OF THE INVENTION

Cellular telephones and other personal electronic devices are a known distraction while driving. Wireless charging systems have been developed for providing a cord-free way to charge a personal electronic device (such as a smart phone, cell phone, laptop, audio player, or tablet) in an automobile. Such systems commonly conform to the Qi wireless charging standard maintained by the Wireless Power Consortium.

In accordance with one conventional system, there is provided a pluggable wireless charging system for charging a personal electronic device in an automobile. Such system typically comprises a base station connected to a power cable that plugs into the socket of a cigarette lighter in an automobile or into a USB dedicated charging port in an automobile. The base station wirelessly charges compatible personal electronic devices.

When using the socket of the cigarette lighter for charging, the base station merely receives power from the socket. The socket communicates no data or command messages. Accordingly, the automobile cannot control the charging process, and the personal electronic device that is being charged cannot provide any data regarding its charging process to the automobile.

When using the USB port for charging, the base station merely receives power from the USB port, as it is a dedicated charging port. The port communicates no data or command messages. Accordingly, the automobile cannot control the charging process, and the personal electronic device that is being charged cannot provide any data regarding its charging process to the automobile.

### SUMMARY OF THE INVENTION

In accordance with an aspect of the present invention, there is provided a media subsystem for a vehicle. The media subsystem comprises a wireless charger configured for wirelessly charging a personal electronic device and a media hub connected to a vehicle interface via a first communications bus conforming to a first protocol and to the wireless charger via a second communications bus conforming to a second protocol different from the first protocol. The media hub comprises a gateway for converting messages transmitted on the second communications bus in accordance with the second protocol to messages transmitted on the first communications bus in accordance with the first protocol.

In accordance with another aspect of the present invention, there is provided a media system for a vehicle. The media system comprises a vehicle interface, a wireless charger configured for wirelessly charging a personal electronic device, and a gateway coupled to the vehicle interface via a first communications bus conforming to a first protocol and to the wireless charger via a second communications bus conforming to a second protocol different from the first protocol. The gateway is configured for converting messages transmitted on the second communications bus in accordance with the second protocol to messages transmitted on the first communications bus in accordance with the first protocol.

### BRIEF DESCRIPTION OF THE DRAWINGS

For the purpose of illustration, there are shown in the drawings certain embodiments of the present invention. In the drawings, like numerals indicate like elements throughout. It should be understood that the invention is not limited to the precise arrangements, dimensions, and instruments shown. In the drawings:

FIG. 1 illustrates a block diagram of a vehicle media system, in accordance with an exemplary embodiment of the present invention; and

FIG. 2 illustrates a block diagram of an exemplary alternative embodiment of the vehicle media system of FIG. 1, in accordance with an exemplary embodiment of the present invention.

### DETAILED DESCRIPTION OF THE INVENTION

Reference to the drawings illustrating various views of exemplary embodiments of the present invention is now made. In the drawings and the description of the drawings herein, certain terminology is used for convenience only and is not to be taken as limiting the embodiments of the present invention. Furthermore, in the drawings and the description below, like numerals indicate like elements throughout.

Communication of data from a wireless charging system to a vehicle interface is desirable. Also desirable is communication of data from a wireless device being charged by the wireless charging system to the vehicle interface. One solution is to provide an integrated wireless charging system for charging a personal electronic device in an automobile. Such system may include a wireless charger directly integrated with the vehicle bus through a vehicle bus interface. The vehicle bus may be a Controller Area Network (CAN) bus, a Local Interconnect Network (LIN) bus, or a Media Oriented Systems Transport (MOST) bus. Integrating a wireless charging system with a vehicle bus interface adds complexity and cost to the system. Particularly complicated is the software required to provide such integration.

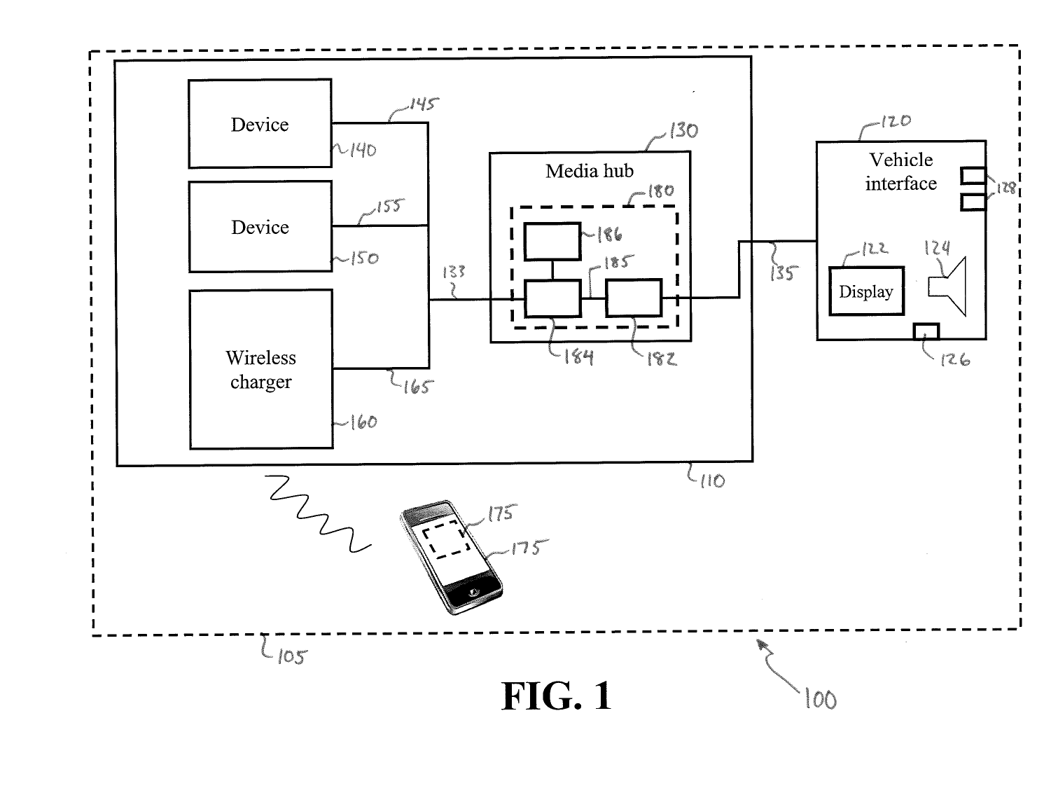

Referring now to FIG. 1, there is illustrated a block diagram of a vehicle media system, generally designated as 100, in accordance with an exemplary embodiment of the present invention. The vehicle media system 100 comprises a media subsystem 110 coupled to a vehicle interface 120 via a communications bus 135. The media subsystem 110, the vehicle interface 120, and the bus 135 are disposed within a vehicle 105.

The vehicle interface 120 comprises a display 122 and an audio output 124. The display 122 is configured for displaying information about the vehicle interface 120 or the vehicle 105, and the audio output 124 is configured for reproducing audio provided by the vehicle interface 120. The display 122 may be a segmented LED or an LCD display. The display 122 and the audio output 124 can be integrated into the vehicle interface 120, i.e., mounted thereon, or separate therefrom and mounted remotely.

In an exemplary embodiment, the vehicle interface 120 is a stereo system. The display 122 is configured for displaying information about the stereo system, such as information regarding radio stations, CDs being played, digital audio from personal electronic devices, audio equalization, etc. The audio output 124 is configured for reproducing audio provided by radio stations, CDs, digital audio provided by personal electronic devices, etc. It is contemplated that the vehicle interface 120 may be an interface to any system, e.g., climate, entertainment, global positioning, etc., of the vehicle 105 in other relevant exemplary embodiments. In such other embodiments, the display 122 provides information about such system, and the audio output 124 reproduces audio provided by such system.

The bus 135 transmits messages or data formatted according to a first protocol. The bus 135 is not a vehicle-specific bus, such as a Controller Area Network (CAN) bus, a Local Interconnect Network (LIN) bus, or a Media Oriented Systems Transport (MOST) bus. For purposes herein, a “vehicle specific bus” is defined to be a CAN bus, a LIN bus, or a MOST bus, and a “non-vehicle-specific bus” is defined to be a bus that is not a CAN bus, a LIN bus, or a MOST bus. In an exemplary embodiment, the bus 135 is a USB cable, and the messages it transmits are USB messages in a USB format.

The vehicle interface 120 may include any number of USB ports 126 that interface with the bus 135. It is contemplated that the vehicle interface may also include any number of ports 128, such as media ports, media interface hubs, HDMI ports, AC outlets, media ports, high-voltage power outlets (HVPOs), AUX input, etc.

The media subsystem 110 further comprises a media hub 130, one or more devices 140, 150, and a wireless charger 160 for wirelessly charging a personal electronic device 170 via magnetic induction. The devices 140 and 150 may be any type of input device, e.g., a volume control, a station present input, an input for switching the media subsystem 110 to an AUX input, etc. The input devices may be embodied as any of a knob, button, capacitive sensor, switch, etc. Alternatively, either or both of the devices 140 and 150 may be any of a GPS device, an optical disc player, such as a CD player or a DVD player, etc.

The devices 140, 150 are connected, respectively, to communications busses 145, 155, which connect to a main communications bus 133 for communicating with the media hub 130. The wireless charger 160 is connected to a communications bus 165, which is connected to the main bus 133 for communicating with the media hub 130. The busses 133, 145, 155, and 165 transmit messages or data formatted according to a second protocol that is different from the first protocol. In an exemplary embodiment, the busses 133, 145, 155, and 165 are non-vehicle specific busses, and the protocols they follow and the data they transmit are for non-vehicle-specific busses. In another exemplary embodiment, the busses 133, 145, 155, and 165 are inter-integrated circuit (I2C) busses (a serial computer bus invented for attaching low-speed peripherals to controllers and embedded systems), and the messages they transmit are I2C messages. In an exemplary embodiment, the media subsystem 110 is implemented on a printed circuit board and is connected by wire traces. In another exemplary embodiment, the media subsystem 110 is implemented on multiple printed circuit boards which are connected by a ribbon or flex cable.

The media hub 130 comprises a gateway 180 between the bus 133 and the bus 135. The gateway 180 is implemented both in hardware in the media hub 130 and in software executed by the hardware for converting data between the formats used on the busses 133 and 135. The gateway 180 comprises a hub 182 comprising a plurality of ports, one of which is connected to the bus 135. The gateway 180 further comprises a processing device 184 and a memory 186 outside of the hub 182. The processing device 184 is connected to the hub 182 via a communications bus 185.

In the exemplary embodiment of the gateway 180 illustrated in FIG. 1, the processing device 184 is embodied as a processor, controller, microprocessor, etc., within the gateway 180 and is programmed with software instructions stored in the memory 186. The software instructions are loaded by the processing device 184 from the memory 186 and are executed by the processing device 184 to cause the processing device 184 to perform gateway functionality of the gateway 180.

The gateway functionality of the gateway 180 is now described. The media hub 130, more specifically the gateway 180, and more specifically the programmed processing device 184 therein, receives messages from the devices 140, 150 and the wireless charger 160 over the bus 133 formatted in accordance with the second protocol and converts them to messages formatted in accordance with the first protocol for transmission to the hub 182 over the bus 185. The hub 182 receives the messages formatted in accordance with the first protocol and transmits them to the vehicle interface 120 over the bus 135.

Continuing with the description of the gateway functionality of the gateway 180, for messages going in the opposite direction, the media hub 130, more specifically the gateway 180, and more specifically the programmed hub 182 therein, receives messages from the vehicle interface 120 over the bus 135 formatted in accordance with the first protocol. The hub 182 forwards such messages to the programmed processing device 184 over the bus 185 in the first protocol. The programmed processing device 184 receives such messages over the bus 185 formatted in accordance with the first protocol and converts them to messages formatted in accordance with the second protocol for transmission to the devices 140, 150 or the wireless charger 160 via the bus 133 and respective busses 145, 155, 165.

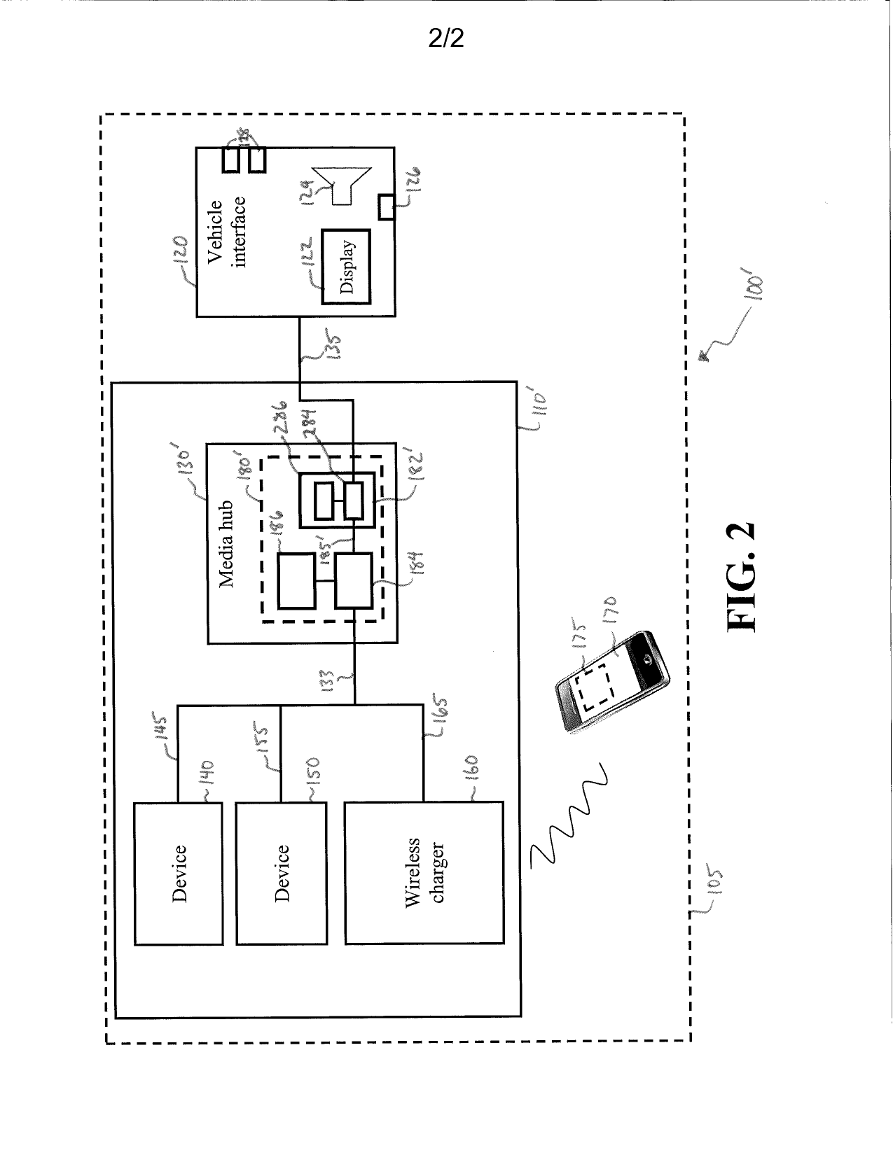

Referring now to FIG. 2, there is illustrated an exemplary alternative embodiment of the vehicle media system 100, generally designated as 100′ in FIG. 2, in accordance with an exemplary embodiment of the present invention. The vehicle media subsystem 100′ comprises an exemplary alternative embodiment of the media subsystem 110, generally designated in FIG. 2 as 110′. The media subsystem 110′ comprises an exemplary alternative embodiment of the media hub 130, generally designated in FIG. 2 as 130′. The media hub 130′ comprises an exemplary alternative embodiment of the gateway 180, generally designated as 180′ in FIG. 2. The gateway 180′ comprises a hub 182′, a microprocessor 184′, a communications bus 185′, and a memory 186′. These components are similar to the respective hub 182, microprocessor 184, communications bus 185, and memory 186 of FIG. 1. Their differences are described below.

The hub 182′ comprises a processing device 284 and a memory 286. The processing device 284 is embodied as a processor, controller, microprocessor, etc., within the hub 182′ and is programmed with software instructions stored in the memory 286. The software instructions are loaded by the processing device 284 from the memory 286 and are executed by the processing device 284 to cause the processing device 284 to perform gateway functionality of the gateway 180′.

The gateway functionality of the gateway 180′ is now described. The media hub 130′, more specifically the processing device 184 therein, receives messages from the devices 140, 150 and the wireless charger 160 formatted in accordance with the second protocol via the bus 133 and transmits the messages to the hub 182′ and more specifically to the processing device 284 of the hub 182′ via the bus 185′ in the second protocol. The programmed processing device 284 receives the messages over the bus 135 formatted in accordance with the second protocol and converts them to messages formatted in accordance with the first protocol for transmission to the vehicle interface 120 over the bus 135.

Continuing with the description of the gateway functionality of the gateway 180′, for messages going in the opposite direction, the media hub 130′, more specifically the gateway 180′, and more specifically the programmed processing device 284 of the hub 182′ receives messages from the vehicle interface 120 over the bus 135 formatted in accordance with the first protocol. The programmed processing device 284 of the hub 182′ converts the received messages to messages formatted in accordance with the second protocol for transmission to the processing device 184 over the bus 185. The processing device 184 receives the messages over the bus 135 formatted in accordance with the second protocol and transmits (distributes) them to the devices 140, 150 or the wireless charger 160 via the bus 133 and respective busses 145, 155, 165 in the second protocol.

With reference to FIGS. 1 and 2, it is noted that the devices 140, 150 and the wireless charger 160 can each communicate in accordance with a same communication protocol or different communication protocols. Thus, while the devices 140, 150, 160 are described as having a same second protocol, it should be understood that the device 140 can communicate by a second protocol, the device 150 can communicate by a third protocol, and the wireless charger 160 can communicate by a fourth protocol, where the second, third and fourth protocols are different from each other. In that embodiment, the media hub 130, 130′ converts between the first protocol and each of the second, third, and fourth protocols and vice versa. Still further, other devices and other protocols can be utilized within the spirit and scope of the invention.

Although FIGS. 1 and 2 illustrate that the devices 140, 150 and the wireless charger 160 are disposed within the media subsystem 110, 110′, it is contemplated that the devices 140, 150 and the wireless charger 160 need not be co-located with the media hub 130, 130′. Other exemplary embodiments in which the devices 140, 150 and the wireless charger 160 are disposed throughout the vehicle 105 remotely from the media hub 130, 130′ are contemplated. Furthermore, still other exemplary embodiments in which the devices 140, 150 and the wireless charger 160 are integrated with the media hub 130, 130′ are contemplated.

As illustrated in FIGS. 1 and 2, the vehicle media system 100, 100′ includes one respective media subsystem 110, 110′. It is to be understood that the vehicle media system 100, 100′ is not limited to including only one respective media subsystem 110, 110′. Other embodiments in which the vehicle media system 100, 100′ includes two or more respective media subsystems 110, 110′ are contemplated. Furthermore, other embodiments in which the media subsystem 110, 110′ comprises two or more respective hubs 130, 130′ are contemplated. For example, the media subsystem 110, 110′ may include one respective media hub 130, 130′ for each device 140, 150 and wireless charger 160.

The gateway of the media hub 130, 130′ provides access to data of the wireless charger 160 by the vehicle 105, specifically the vehicle interface 120, and access to data of the vehicle 105, specifically the vehicle interface 120, to the wireless charger 160. Data provided to the vehicle interface 120 by the wireless charger 160 includes any of an indication of charge detection of the personal electronic device 170, i.e., whether a battery 175 of the personal electronic device 170 is charging, a level of charge of the battery 175 of the personal electronic device 170, and an indication of whether a foreign object is between the wireless charger 160 and the personal electronic device 170 (also referred to herein as “indication of foreign objection detection”). The indication of charge detection and the level of charge of the battery 175 are communicated by the personal electronic device 170 to the wireless charger 160 by near field communication, as described below, and the wireless charger 160 forwards this data to the vehicle interface 120 via the media hub 130, 130′ for display on the vehicle interface 120.

In operation, the user places the personal device 170 on the wireless charger 160, which is disposed near an outer surface of the media subsystem 110. This activates the wireless charger 160 to wirelessly charge the battery 175 by magnetic induction. At the same time, the personal device 170 tracks the status of the battery 175, such as the status of the charge, whether the battery 175 is charging, the electric current created through magnetic induction with the wireless charger 160, and the power consumed by the personal electronic device 170 when charging the battery 175, and can display any of this information on the display device of the personal device 170. The charge status can be, for instance, an indication of the percentage of charge on the battery 175 (e.g., 75% charged), and the amount of time needed to fully charge the battery 175. The personal electronic device 170 may display an icon or animation indicating that its battery 175 is charging. The personal electronic device 170 outputs data indicating whether the battery 175 of the personal electronic device 170 is charging and the level of charge of the battery 175 of the personal electronic device 170 by a wireless near field signal. In an exemplary embodiment, the wireless near field signal conforms to the Qi protocol maintained by the Wireless Products Consortium.

That signal is received by the wireless charger 160, specifically a near-field receiver therein, and transmitted as data via communications busses 165, 133 to the media hub 130. The media hub 130, 130′ interprets the information in the transmitted data based on the protocol used by the wireless charger 160, and sends a data signal to the vehicle interface 120 via communications bus 135. The vehicle interface 120 can output that information (in this case, the battery status) to the user via the display 122 and/or the audio output 124. For instance, if the vehicle interface 120 is a radio, the battery status information can be displayed on the radio display 122, or audibly announced over the radio speakers 124. The visual/audio output can be continuous or at predetermined times (such as every 5% additional charge, every 15 minutes, etc.) or when selected by the user through the vehicle interface 120.

The indication of foreign objection detection is determined by the wireless charger 160. The personal electronic device 170 transmits to the wireless charger 160 an indication of the power received by the personal electronic device 170 for charging its battery 175. The wireless charger 160 receives the indication transmitted by the personal electronic device 170 by near field communication. The wireless charger 160 compares the power it provides to the personal electronic device 170 via electromagnetic radiation to the power received by the personal electronic device 170 for charging its battery 175. If the two power levels differ by more than a predetermined amount, the wireless charger 160 determines that a foreign object is located between the wireless charger 160 and the personal electronic device 170 and is interfering with the charging of the battery 175. The wireless charger 160 transmits an indication of whether there is such a foreign object disposed between the wireless charger 160 and the personal electronic device 170 to the vehicle interface 120 via the media hub 130, 130′ for display of the indication on the vehicle interface 120 and to the personal electronic device 170 via near field communication for display of the indication on the personal electronic device 170. A foreign object may be anything that interferes with the magnetic field produced by the wireless charger 160 for charging the personal electronic device 170.

The media subsystem 110, 110′ provides a cost effective solution to access the wireless charger 160 by the vehicle interface 120. It avoids an interface with a vehicle-specific bus (CAN, LIN, or MOST) and associated software, thereby reducing cost. Instead of an interface with a vehicle-specific bus and associated software, the media subsystem 110, 110′ includes a respective media hub 130, 130′ which provides a direct gateway between the vehicle interface 120 and the wireless charger 160 using non-vehicle-specific busses. Thus, data is tunneled from the wireless charger 160 to the vehicle interface 120. In an exemplary embodiment, it makes use of existing USB connections on the vehicle interface 120, which reduces cost and complexity. In such embodiment, the gateway 180, 180′ is programmed with software (stored in the memory 186, 286) that includes a simple instruction set to translate USB messages (corresponding to the first protocol discussed above) to the second protocol and vice versa. It is contemplated that the second protocol may be I2C.

Although the embodiments discussed above with respect to FIGS. 1 and 2 use a wireless charger 160 for wirelessly charging the personal electronic device 170, other embodiments in which the vehicle media system 100, 100′ is configured for wired charging are contemplated. For example, in one other embodiment, the wireless charger 160 is replaced by a USB plug or interface assembly containing a USB plug, such as the interface device described in U.S. Provisional Application No. 61/899,367 (“the '367 Application”), the contents of which are incorporated herein by reference, but the media hub 130, 130′ still retains the gateway 180 functionality. In another exemplary embodiment, the vehicle interface 120 further includes a USB plug or detachable charging unit, such as that described in the '367 Application, for charging the personal electronic device 170. In such embodiment, the vehicle interface 120 accesses the charging information described above as being accessed by the wireless charger 160. The vehicle interface 120 includes a processing device, such as a microprocessor, microcontroller, etc., programmed with software instructions stored on a computer-readable tangible medium that when executed by the processing device cause it to access and display the charging information on the display 122 or reproduce it via the audio outlet 124.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. An media subsystem for a vehicle, the media subsystem comprising:
a wireless charger configured for wirelessly charging an electronic device; and
a processing device connected to a vehicle interface via at least a first communications bus conforming to a first protocol and to the wireless charger via at least a second communications bus conforming to a second protocol different from the first protocol, the processing device configured to convert data on the second communications bus in accordance with the second protocol to data on the first communications bus in accordance with the first protocol.

2. The media subsystem of claim 1, wherein the first communications bus is a universal serial bus.

3. The media subsystem of claim 1, wherein the second communications bus is an inter-integrated circuit bus.

4. The media subsystem of claim 1, wherein:
the wireless charger is further configured for:
receiving data, via a near field communication, from the personal electronic device regarding a level of charge of a battery of the personal electronic device; and
transmitting the data to the processing device via the second communications bus conforming to the second protocol; and
the processing device is configured for:
receiving the data from the wireless charger; and
transmitting the data to the vehicle interface via the first communications bus conforming to the first protocol for being displayed on the vehicle interface.

5. The media subsystem of claim 1, wherein the wireless charger is further configured for receiving data, via a near field communication, from the personal electronic device regarding a level of power consumed while charging a battery of the personal electronic device.

6. The media subsystem of claim 5, wherein the wireless charger is further configured for measuring power provided to the personal electronic device wirelessly.

7. The media subsystem of claim 6, wherein the wireless charger is further configured for:
comparing the data regarding the level of power consumed while charging the battery to the power provided to the personal electronic device wirelessly to compute a difference; and
transmitting, to the processing device via the second communications bus conforming to the second protocol, an indication that a foreign object is disposed between the wireless charger and the personal electronic device if the difference is greater than a predetermined amount.

8. The media subsystem of claim 7, wherein the processing device is further configured for:
receiving the indication that a foreign object is disposed between the wireless charger and the personal electronic device; and
outputting the indication on the first communications bus to the vehicle interface for being displayed on the vehicle interface.

9. The media subsystem of claim 1, further comprising a media hub and a third communications bus conforming to the first protocol, wherein the processing device is connected to the media hub via the first communications bus, and the media hub is connected to the vehicle interface via at least the third communications bus.

10. The media subsystem of claim 1, further comprising a media hub comprising the processing device.

11. The media subsystem of claim 10, wherein the media subsystem further comprises:
a second processing device; and
a third communications bus conforming to the second protocol,
wherein the processing device of the media hub is connected to the second processing device via the second communications bus, and the second processing device is connected to the wireless charger via at least the third communications bus.

12. An media system for a vehicle, the media system comprising:
a vehicle interface;
a wireless charger configured for wirelessly charging a personal electronic device; and
a gateway coupled to the vehicle interface via at least a first communications bus conforming to a first protocol and to the wireless charger via at least a second communications bus conforming to a second protocol different from the first protocol, the gateway configured for converting messages transmitted on the second communications bus in accordance with the second protocol to messages transmitted on the first communications bus in accordance with the first protocol.

13. The media system of claim 12, wherein the first communications bus is a universal serial bus.

14. The media system of claim 12, wherein the second communications bus is an inter-integrated circuit bus.

15. The media system of claim 12, wherein:
the wireless charger is further configured for:
receiving data, via a near field communication, from the personal electronic device regarding a level of charge of a battery of the personal electronic device; and
transmitting the data to the gateway via the second communications bus conforming to the second protocol; and
the gateway is configured for:
receiving the data from the wireless charger; and
transmitting the data to the vehicle interface via the first communications bus conforming to the first protocol for being displayed on the vehicle interface.

16. The media system of claim 12, wherein the wireless charger is further configured for receiving data, via a near field communication, from the personal electronic device regarding a level of power consumed while charging a battery of the personal electronic device.

17. The media system of claim 16, wherein the wireless charger is further configured for measuring power provided to the personal electronic device wirelessly.

18. The media system of claim 17, wherein the wireless charger is further configured for:
comparing the data regarding the level of power consumed while charging the battery to the power provided to the personal electronic device wirelessly to compute a difference; and
transmitting, to the gateway via the second communications bus conforming to the second protocol, an indication that a foreign object is disposed between the wireless charger and the personal electronic device if the difference is greater than a predetermined amount.

19. The media system of claim 18, wherein the gateway is further configured for:
receiving the indication that a foreign object is disposed between the wireless charger and the personal electronic device; and
outputting the indication on the first communications bus to the vehicle interface for display.

20. The media system of claim 12, wherein the gateway comprises a processing device configured for converting messages transmitted on the second communications bus in accordance with the second protocol to messages transmitted on the first communications bus in accordance with the first protocol.

21. The media system of claim 20, wherein:
the gateway further comprises a media hub;
the media system further comprises a third communications bus conforming to the first protocol; and
the processing device is connected to the media hub via the first communications bus, and the media hub is connected to the vehicle interface via at least the third communications bus.

22. The media subsystem of claim 20, wherein the gateway further comprises a media hub comprising the processing device.

23. The media subsystem of claim 22, wherein:
the gateway further comprises a second processing device;
the media system further comprises a third communications bus conforming to the second protocol;
the processing device of the media hub is connected to the second processing device via the second communications bus; and
the second processing device is connected to the wireless charger via at least the third communications bus.
